(19) United States
(12) Patent Application Publication
(10) Pub. No.: US 2004/0261329 A1
(43) Pub. Date: Dec. 30, 2004

(54) Apparatus for adjusting the elevation of a planar surface with threaded and non-threaded components

(76) Inventors: William E. Kugler, Denver, CO (US); Stephen J. Knight III, Littleton, CO (US)

Correspondence Address: SHERIDAN ROSS PC, 1560 BROADWAY, SUITE 1200, DENVER, CO, 80202

(21) Appl. No.: 10/831,514

(22) Filed: Apr. 23, 2004

Related U.S. Application Data
(63) Continuation-in-part of application No. 10/109,786, filed on Mar. 29, 2002.
Application No. 10/109,786 is a continuation-in-part of application No. 09/575,335, filed on May 19, 2000, now Pat. No. 6,363,685.

(51) Int. Cl. E04B 9/00; A61C 13/28

(52) U.S. Cl. 52/126.6

(57) ABSTRACT

An adjustable support pedestal is provided which can selectively raise or lower the level of a building surface or industrial component such as a paver, pipe, etc. is provided herein. More specifically, a base member, crown member, and at least one non-threaded tubular stem are provided which can be selectively adjusted to raise or lower the height of the building surface.

This application is a Continuation-In-Part of pending U.S. patent application Ser. No. 10/109,786, filed Mar. 29, 2002, which is a Continuation-In-Part of U.S. patent application Ser. No. 09/575,335, now U.S. Pat. No. 6,363,685, filed May 19, 2000, both applications being incorporated herein by reference in their entirety. In addition, this application is related to, and incorporates by reference in its entirety, U.S. patent application Ser. No. 10/646,090, filed Aug. 22, 2003, which also claims the benefit of the above-listed applications.

### FIELD OF THE INVENTION

The present invention relates to construction apparatus, and more specifically a device which is used to selectively adjust the height, level and orientation of a building surface such as a walk, deck, floor, or porch during the construction thereof, and which may include a plurality of adjustable caps for greater installation flexibility.

### BACKGROUND OF THE INVENTION

It is often imperative that the surface of patios, decks, floors and other building surfaces maintain a level surface or a surface with a gradual, consistent grade. This goal is sometimes difficult to achieve if, for example, the building surface is to be situated over ground that is uneven. Previous attempts have been made by builders to effectively eliminate this problem, including leveling the uneven surface by hand or with machinery, using wedge shims, spacers, or selectively cutting numerous vertical support work pieces until the proper length and resultant grade is obtained. Unfortunately, all of the aforementioned methods are time consuming, generally ineffective and expensive.

One possible solution to the aforementioned problem was disclosed in U.S. Pat. No. 5,588,264 to Buzon (hereinafter the '264 patent). In the '264 patent, a leveling device includes a tubular stem that is threadingly coupled with a crown member and a base member. To adjust the elevation of a work surface, such as a patio deck, the tubular stem is rotated either counter clockwise into the base member to increase the height of the leveling device, or rotated clockwise to decrease the height of the leveling device. This device allows portions of the work surface to be raised or lowered quickly and effectively without having to ad shims, move dirt or cut additional lumber or other materials. The devices disclosed and covered in the '264 patent have a specific limited range of height since differing units can only be raised within a range of approximately 3 inches. Thus, the device is very limited in use and one unit cannot be used in a majority of situations where a custom fit piece is required to level a building surface. Further, no type of non-skid shim plates were provided in the '264 patent to prevent shifting of the building surface resting on the adjustable leveling device. Additionally, no attachable shims are provided to quickly modify the total height of the adjustable leveling device or bring the support element into a more vertical position. Thus, the use of shims and other make-shift work pieces are often required in combination with the leveling apparatus which is both time consuming and quite ineffective.

Yet another problem associated with leveling devices in the prior art is that inexpensive, non-threaded pipe, such as PVC pipe is not employed. PVC pipe is desirable because it may be easily trimmed to a predetermined length to form a portion of the leveling device, thus allowing workers to make real-time height adjustments while not being constrained by the limitations of a completely threaded leveling device. Furthermore, PVC pipe is generally available on most construction sites, and is simplistic to cut with commonly used tools such as a chop saw or hand saw.

Another problem found in the art is the inability to utilize a standard vertical adjustment aperture with a plurality of removable “heads” which are adapted for a multiplicity of uses. For example, one type of head may be designed to align and support a structural member such as a beam or stud, while a different type of head may include one or more projections designed to support a grating material. Other adjustable heads may be designed to support pipe or any other type of material where elevation and alignment are critical.

Thus, there is a long felt need in the construction trades and industry in general for a leveling device which is simplistic to use, is stable, can be modified on site with common hand tools, and which is adjustable with a variety of accessory components to provide a wide range of lengths.

### SUMMARY OF THE INVENTION

It is thus one aspect of the present invention to provide an adjustable leveling apparatus that may be modified quickly and easily with a portable hand saw to accommodate a variety of different lengths to support a deck, porch floors or mechanical equipment (such as pumps) or other similar building surfaces. The leveling device may be used independently, or more commonly with a plurality of other adjustable support devices to create a level surface or a surface with a slight grade for drainage purposes.

It is another aspect of the present invention to provide a leveling device that is selectively expandable to a much greater length by the use of a coupling mechanism which allows the interconnection of at least two distinct lengths of a tubular stem material. Additionally, in another aspect of the present invention the tubular stem is integrally interconnected to a base member, and may be used without any type of coupler device. In this configuration the total length of the adjustable support piece is significantly reduced and can be used in situations where the vertical clearance between an upper building surface and a lower surface is less than about three inches.

In another aspect of the present invention, a base member is provided that supports the tubular stem and crown member, and which has a greatly increased and widened base surface to provide stability. Further, the base member may have a plurality of drainage weep holes to allow water to drain through the substrate to avoid freezing of trapped water and potential breakage. Further, a plurality of attachment apertures may be provided to receive nails, screws and other attachment hardware to allow the base member to be interconnected to a lower building surface.

It is yet another aspect of the present invention to provide a crown member that is screwed onto the tubular stem member and which can be raised or lowered to selectively adjust the total height of the leveling apparatus. The top of the crown member preferably includes a plurality of alignment tabs that are used to align the construction materials such as a wood deck panel, a patio paver, cement block or framing joist. Alternatively, one or more of the alignment tabs can be quickly removed to provide a flat support surface.

It is a further aspect of the present invention to provide a removable crown member which matingly engages the upper planar surface of the crown member to provide slightly more length to the adjustable support piece. Preferably, the removable crown member has a plurality of vertically extending alignment tabs which are used to align the building surface. Further, a non-skid pad may be provided which fits on either the upper planar surface or the crown member. The non-skid pad is preferably made of a rubber, and has a sufficient coefficient of friction to prevent the deck panels, stone pavers, or other common materials from shifting on the adjustable support piece after installation.

It is yet a further aspect of the present invention to provide a selectively adjustable leveling apparatus that employs at least one non-threaded pipe, associated coupling, a threaded pipe portion and a base or crown member. Thus, the non-threaded pipe can be utilized to interconnect a crown member to an upper portion of a coupling, or alternatively to interconnect a base member to a lower portion of the coupling. In either embodiment it is anticipated that a threaded pipe would additionally be utilized to allow the leveling apparatus to be quickly adjusted to a desired vertical height by rotation of at least one of the crown member, base member, associated coupler or threaded pipe. Alternatively, two non-threaded pipes could be used in conjunction with a threaded coupling member which is adapted to engage the two non-threaded pipes, yet employs a threaded portion which allows the selective adjustment of height by rotation.

In another aspect of the present invention, a head or “cap” member is provided which may be removably interconnected to an upper portion of the crown member, and which has any number or geometric configurations designed to support, align or position a structural member such as a beam, stud or pipe. In one embodiment of the present invention the head member may have a plurality of pins or studs projecting downward which matingly engages one or more apertures positioned in an upper surface of the crown member. As appreciated by one skilled in the art, the head member may be interconnected to an upper portion of the crown by various other means such as screws, nails, adhesive materials, or other ways known in the art. Further, the geometric configuration on the upper portion of the head member may include one or more tabs or rails aligned in a parallel or perpendicular orientation, one or more male studs or pins projecting upwards to receive a grating material, or a “V” or “U” shaped guides with one or more rollers positioned thereon to support a pipe and accommodate movement as a result of thermal expansion or contraction. Thus, the number of possible geometric configurations that may be utilized in conjunction with the selectively removable head member are limited only by the type and nature of material or structure designed to be supported or aligned on top of the head.

Thus, in one aspect of the present invention, an adjustable support piece for selectively adjusting the elevation of a building surface is provided, comprising:

a non-threaded cylindrical member comprising an upper end, a lower end and a length defined therebetween;

a threaded cylindrical member comprising an upper end, a lower end and a length defined therebetween;

a coupling member with a first portion for selective engagement with said non-threaded cylindrical member and a second portion for selective engagement with said threaded portion;

a base member having an upper surface and a lower surface, said upper surface operable interconnected to at least one of said non-threaded cylindrical member and said threaded cylindrical member, said lower surface adapted for engagement with a fixed surface; and

a crown member having an upper surface and a lower surface, said lower surface operable interconnected to at least one of said non-threaded cylindrical member and said threaded cylindrical member, and said upper surface adapted for supporting said building surface, wherein rotation of at least one of said base member, said crown member, said threaded cylindrical member and said coupling changes the elevation of said crown member with respect to the building surface.

The Summary of the Invention is neither intended nor should it be construed as being representative of the full extent and scope of the present invention. The present invention is set forth in various levels of detail in the Summary of the Invention as well as in the attached drawings and the Detailed Description of the Invention and no limitation as to the scope of the present invention is intended by either the inclusion or non-inclusion of elements, components, etc. in this Summary of the Invention.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, serve to explain the principles of these embodiments.

FIG. 1 is a front perspective view of one embodiment of the present invention being used to support a building surface such as wood decking and/or concrete pavers;

FIG. 2 is a front perspective view showing an adjustable support piece with tubular stems of various lengths;

FIG. 3 is an exploded view of the adjustable support piece showing a base member, two tubular stems for interconnection with a coupling, and a crown member;

FIG. 4 are front perspective views of an assembled adjustable support piece and a non-skid shim plate that fits on the upper planar surface of the crown member;

FIG. 5 is an exploded view of the adjustable support piece with a crown coupling member that matingly engages the upper planar surface of the crown member to provide a slight increase in the total length of the adjustable support piece;

FIG. 6 is a front perspective view of an alternate embodiment of the present invention where the tubular stem is integrally interconnected to the base member, thus reducing the total height of the adjustable support piece.

FIG. 7 is a front elevation view of one embodiment of the present invention with a head or cap member used to support a pipe;

FIG. 7A is a front elevation view of the embodiment shown in FIG. 7 without the pipe positioned on a multi-purpose head to show a roller or glide surface that is adapted to receive the pipe;

FIG. 8 is a front perspective view of one embodiment of the present invention wherein the head is used to support intersecting building materials such as studs positioned at a right angle;

FIG. 8A is a front elevation view of the embodiment shown in FIG. 8;

FIG. 8B is an alternative embodiment of the invention shown in FIG. 8 that is used to support a single 2×4 inch stud;

FIG. 8C is an alternative embodiment of the invention shown in FIG. 8 that is used to support wider building materials;

FIG. 8D is an alternative embodiment of the invention shown in FIG. 8 that is used to support a facia/rim joist;

FIG. 8E is a front perspective view of the embodiment shown in FIG. 8, and identifying the positioning of a stud;

FIG. 8F is a front elevation view of one embodiment of the present invention and identifying the positioning of various frame and plank materials on top of an adjustable support piece with selectively removable heads;

FIG. 8G is a front elevation view of an alternative embodiment of the invention shown in FIG. 8F in use with different building materials;

FIG. 9 is a front perspective view of one embodiment of a head of the present invention shown being positioned on an adjustable support piece;

FIG. 9A is a front section view of the embodiment shown in FIG. 9 taken along line “A-A”;

FIG. 9B is a partial top plan view of the embodiment shown in FIG. 9;

FIG. 9C is a front sectional view of the embodiment shown in FIG. 9 and having an optional drive head configuration;

FIG. 10 is an exploded front perspective view of one head embodiment of the present invention shown positioned above an adjustable support piece;

FIG. 10A is a front elevation view of the embodiment shown in FIG. 10;

FIG. 10B is a top plan view of the embodiment shown in FIG. 10 and further including a section of grating material positioned thereon;

FIG. 11 is a front perspective view of an alternative head embodiment of a head of the present invention positioned above an adjustable support piece;

FIG. 11A is a front elevation view of the embodiment shown in FIG. 11;

FIG. 11B is a top plan view of the embodiment shown in FIG. 11, and further including two sections of grating material positioned thereon;

FIG. 12 is a front elevation view of an alternative embodiment of a head of the present invention;

FIG. 12A is a top plan view of the invention shown in FIG. 12, and which is designed for use with four distinct sheets of grating material;

FIG. 13 is a front elevation view of an alternate embodiment of the present invention;

FIG. 14 is a top plan view of the embodiment of the present invention shown in FIG. 13;

FIG. 15 is a front sectional view of the embodiment of the invention shown in FIG. 13; and

FIG. 16 is a front elevation view of the embodiment of the present invention shown in FIG. 13, further including the base member and the crown member.

It should be understood that the drawings are not necessarily to scale. In certain instances, details which are not necessary for an understanding of the invention or which render other details difficult to perceive may have been omitted. It should be understood, of course, that the invention is not necessarily limited to the particular embodiments illustrated herein.

### DETAILED DESCRIPTION

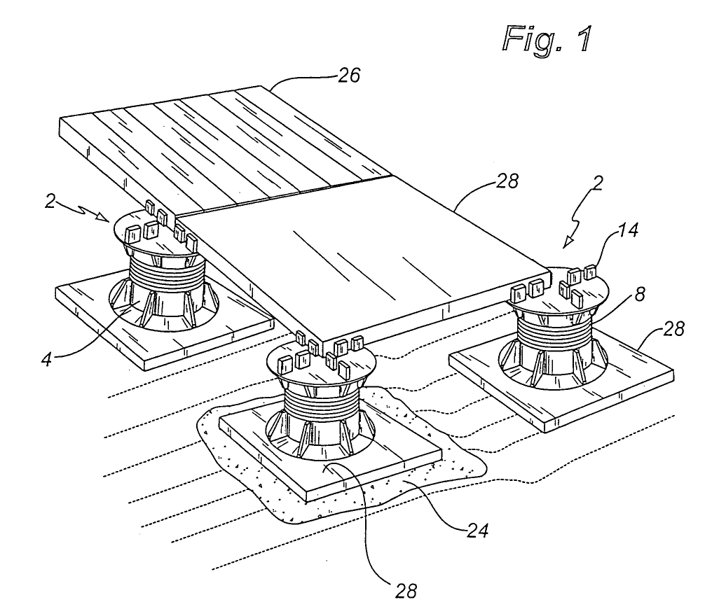

Referring now to the drawings, FIG. 1 identifies three adjustable support pieces 2 of the present invention positioned below a building surface to provide support thereof. As seen in this drawing, the support pieces 2 are typically positioned between a substantially planar surface of a lower building surface and an upper building surface such as a patio deck. For example, a concrete paver 28 may be positioned on top of compacted soil 24 to provide a lower support surface while a concrete paver 28 or alternatively wood decking material 26 is positioned on top of the adjustable support piece 2 to provide an upper building surface. Depending on the uneven elevation of the compacted soil 24, it is necessary for the various corners of the adjustable support pieces 2 to be independently raised and/or lowered to effectively obtain a level building surface. Thus, as seen in FIG. 1, the adjustable support piece 2 on the right hand corner is raised to a greater elevation than the adjustable support piece 2 positioned in the middle due to the lower elevation of the compacted soil 24 shown on the right hand portion of the drawing.

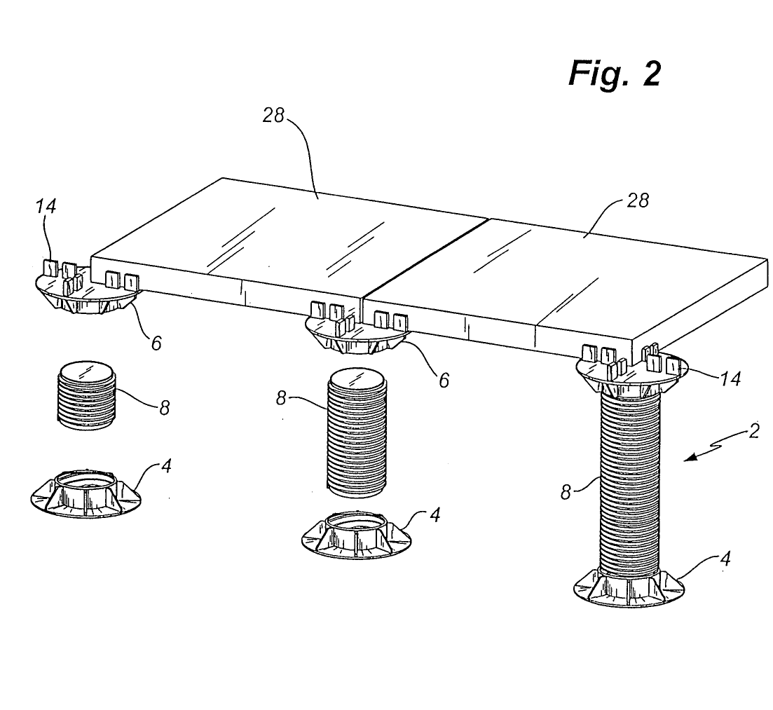

Referring now to FIG. 2, the adjustable support piece 2 is generally shown being used to support two concrete pavers 28 and further identifying exploded views of the adjustable support piece 2. More specifically, the adjustable support piece 2 is comprised of a base member 4, a tubular stem 8, and a crown member 6 which is interconnected to the upper portion of the tubular stem 8. For assembly purposes, the tubular stem 8 is threadingly engaged to inner integral threads 10 positioned within the base member 4 on a lower end, and on an upper end to a crown member 6 which additionally has integral vertical threads 10 extending therefrom. Generally, the tubular stem 8 has an original length at least about 4 times greater than the height of each of the base member 4 and the crown member 6. In a preferred embodiment, the crown member 6 and base member 4 each have a vertical height of about 1.50 inches, while the tubular stem 8 has an original overall length of approximately 12 inches.

To effectively use the adjustable support piece 2 to selectively level a building surface, an approximate height of the desired total height of the adjustable support piece 2 is calculated depending on the approximate elevated height of the upper building surface. Once this height is determined, the tubular stem 8 is typically cut with a portable hand saw and miter box and/or a power saw such as a sawsall (is this product name??). By effectively cutting the length of the tubular stem 8 for any given application, a significant amount of flexibility can be obtained by creating an adjustable support piece 2 which has a minimum length of about 2.25 inches, and/or a total maximum height using one tubular stem of about 15 inches. This flexibility allows the adjustable support piece 2 to be used in a wide variety of applications to effectively support a building surface such as a patio deck.

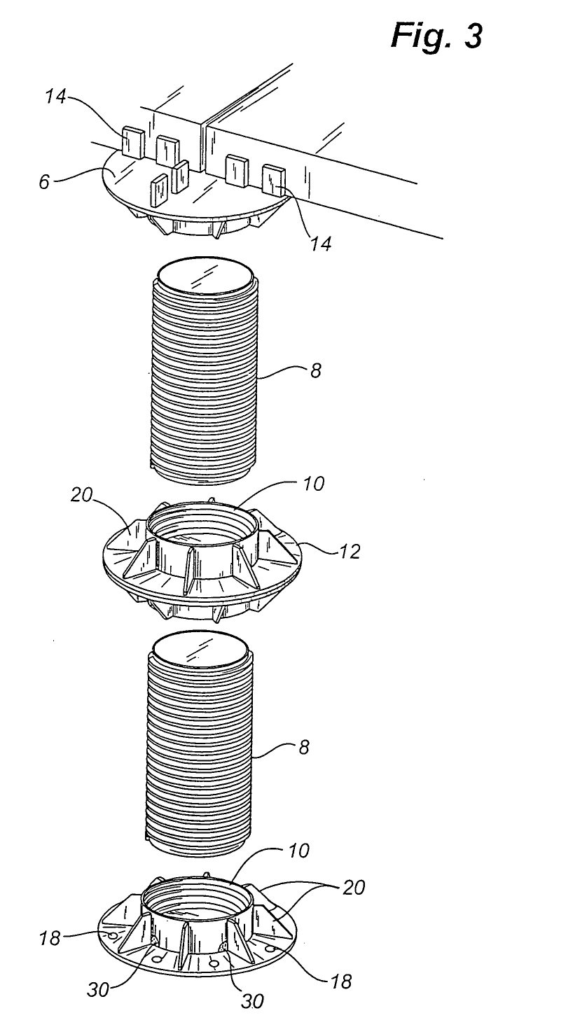

In an alternative embodiment of the present invention shown in FIG. 3, two separate tubular stems 8 may be interconnected by the use of a threaded coupling 12 to make an adjustable support piece 2 having a length effectively two times longer than an adjustable support piece 2 which utilizes only one tubular stem 8. This flexibility is especially beneficial in applications where there is a significant elevation differential between one position of a building surface and another.

The base member 4 is generally comprised of a plastic material such as polyethylene or nylon which is resistant to mold, mildew, and rotting when exposed to moist conditions. In general, the base member 4 has a substantially planar lower surface adapted for resting on an opposing flat surface such as a concrete paver or ground surface. Extending upwardly from the substantially planar surface is a vertical cylindrical member with integral threads 10 positioned therein which are adapted for receiving the tubular stem 8. For reinforcement and support purposes a plurality of support fins 20 preferably interconnect the vertically extending tubular piece of the base member 4 to the substantially planar member on the bottom. In a preferred embodiment, the width of the base member 4 is about 8 inches although lengths between about 6 inches and 12 inches would be quite effective. As further seen in FIG. 3, the base member 4 may additionally have a plurality of drainage weep holes 30 to allow water to drain from within the base member 4. Additionally, a plurality of base apertures 18 may be provided to receive a nail, screw, or other piece of attachment hardware to interconnect the base member 4 to a lower building surface such as a wood beam, or concrete paver. Additionally, gloves or adhesive may be used to attach the base member 4 to a lower building surface in certain applications.

The tubular stem 8 is preferably comprised of a plastic material such as a polyethylene, polypropylene, nylon, or other similar material. Preferably the tubular stem 8 has integral threads extending from a first lower end to a second higher end, with a rate of twist of approximately 5 threads per inch. The tubular stem has a preferred normal diameter of between about 3 inches and 5 inches and more preferably about 4 inches. Additionally, the tubular stem 8 has a length of at least about four times the vertical height of either the base member 4 and crown member 6. This increased initial length of the tubular stem 8 allows the assembled adjustable support piece 2 to be used initially in applications requiring a support piece with a length of about 24 inches, or the tubular stem can be quickly cut with a hand saw to provide a support piece 2 with a length of only about 2.25 inches.

Referring again to FIG. 3, the threaded coupling 12 is designed to be positioned between two tubular stem members 8 to effectively increase the overall length of the adjustable support piece 2. Similar to the base member 4 and crown member 6, the threaded coupling 12 is preferably constructed of a plastic material such as polyethylene, polypropylene, nylon or other similar materials known in the art and which effectively has a diameter which is substantially equivalent to the crown member 6 or base member 4. Additionally, a plurality of support fins 20 may be used to provide structural support to the threaded coupling 12.

The crown member 6 is sized and designed to be threaded onto the upper end of the tubular stem 8. The crown member 6 has a substantially planar upper surface which is interconnected to a cylindrical member which has a plurality of integral threads extending downwardly to receive the tubular stem 8. Similar to the base member 4, a plurality of support fins 20 may be used to provide structural support between the substantially planar upper surface and the downwardly extending integral threaded portion. Additionally, the substantially planar upper surface of the crown member 6 may include a plurality of alignment tabs 14 which are oriented at substantially right angles. The alignment tabs 14 are designed to abut an edge surface of a concrete paver 28, wood decking material 26 or any other type of building surface. Preferably, the alignment tabs 14 are comprised of a brittle plastic material which are integrally interconnected to the upper planar surface of the crown member 6 during manufacturing. The alignment tabs 14 are brittle to allow an installer to selectively break off one or more of the alignment tabs 14 during installation. Further, all of the alignment tabs 14 may be quickly broken off by the use of a hammer or other similar tool to provide a substantially flat surface.

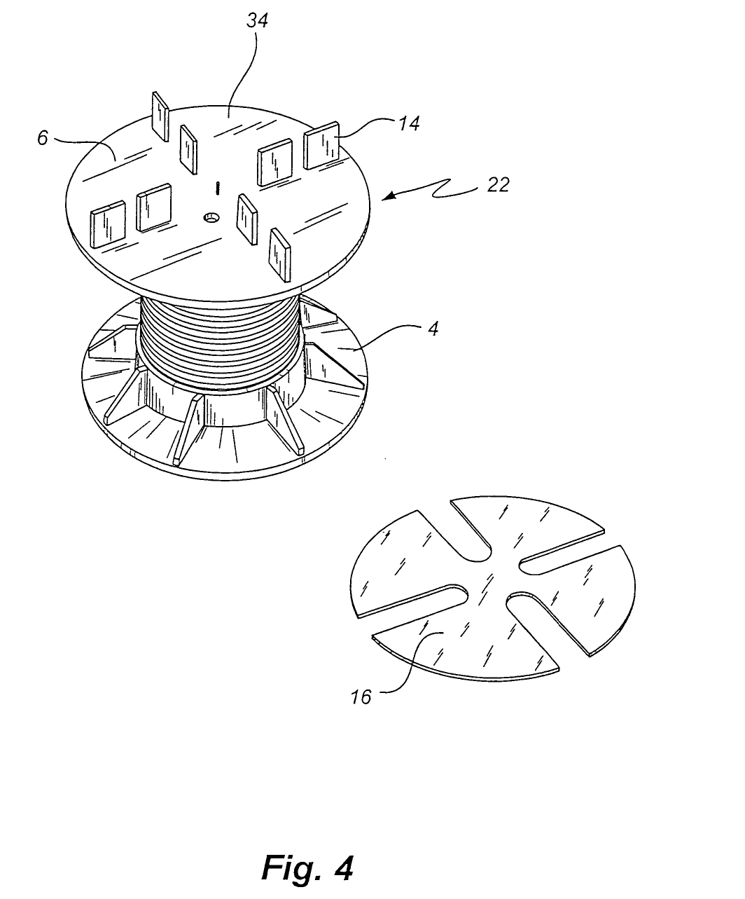

Referring now to FIG. 4, an upper perspective view of an assembled adjustable support piece 2 is provided along with a non-skid shim pad 16 shown to the right. The non-skid shim pad 16 is preferably comprised of a rubber type material which fits on the upper planar surface of the crown member 6. The slots positioned in the non-skid shim pad 16 are designed to matingly fit around the alignment tabs 14. When in place, the non-skid shim pad 16 effectively prevents the concrete pavers 28 or other building materials from sliding and slipping on top of the plastic upper planar surface of the crown member 6. Although other type of materials could be used for the same purpose such as felt, cloth fabrics and other similar materials appreciated by one skilled in the art, products which have a substantially high coefficient of friction are most desirable.

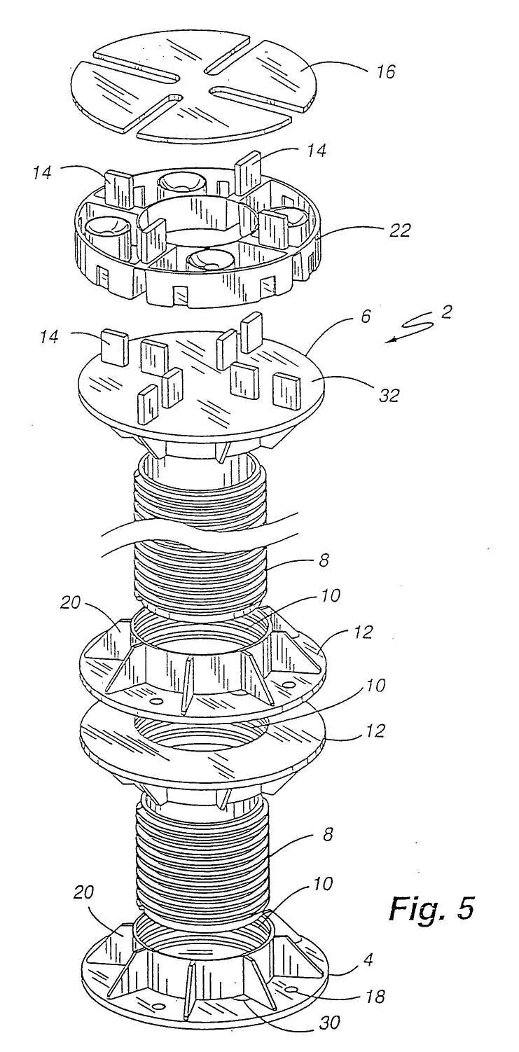

Referring now to FIG. 5 the adjustable support piece 2 is shown in an exploded view which identifies the base member 4, the tubular stem 8, the crown member 6, and a crown spacer 22 positioned on top of the crown member 6 and below the non-skid shim pad 16. The crown spacer 32 is designed to matingly engage the upper surface of a typical crown member 6 by fitting around the alignment tabs 14, and thus providing approximately 0.75 inches in increased height to the adjustable support piece 2. In a preferred embodiment the crown spacer 22 is about 0.5-0.75 inches high, although lengths ranging from about 1 inch to 4 inches may be used. Additionally, the crown spacer 22 preferably has a plurality of alignment tabs 14 extending vertically therefrom which are similar to the crown member 6, and are used for the same purpose to prevent movement of the building surface.

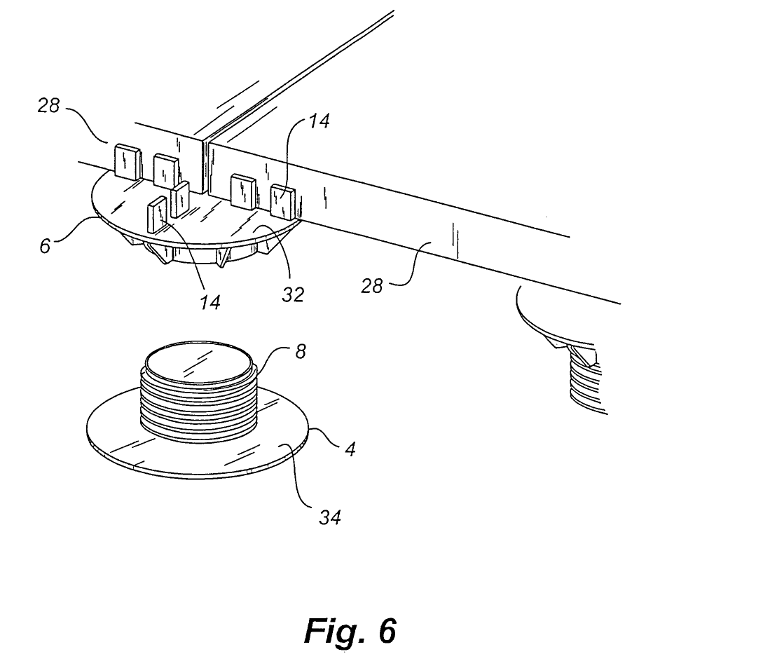

Referring now to FIG. 6, an alternative embodiment of the present invention is provided. More specifically, a front perspective view is shown with the crown member 6 disconnected from the tubular stem 8 and base member 4. However, as shown in the drawing the tubular stem 8 is integrally interconnected to an upper planar portion of the base member 4, as opposed to being an independent component as seen in FIGS. 1-4. This embodiment allows the crown member 6 to be screwed down over the tubular stem 8 until contact is made with the upper planar surface of the base member 4, and thus significantly reducing the total length of the adjustable support piece 2. In fact, the total length between the lower planar surface of the base member 4 and the upper planar surface of the crown member 6 is only 2.25 inches. Thus, this configuration allows the adjustable support piece to be used in locations where the total vertical distance between the upper building surface and lower building surface is very small, i.e., less than about 2.5 inches.

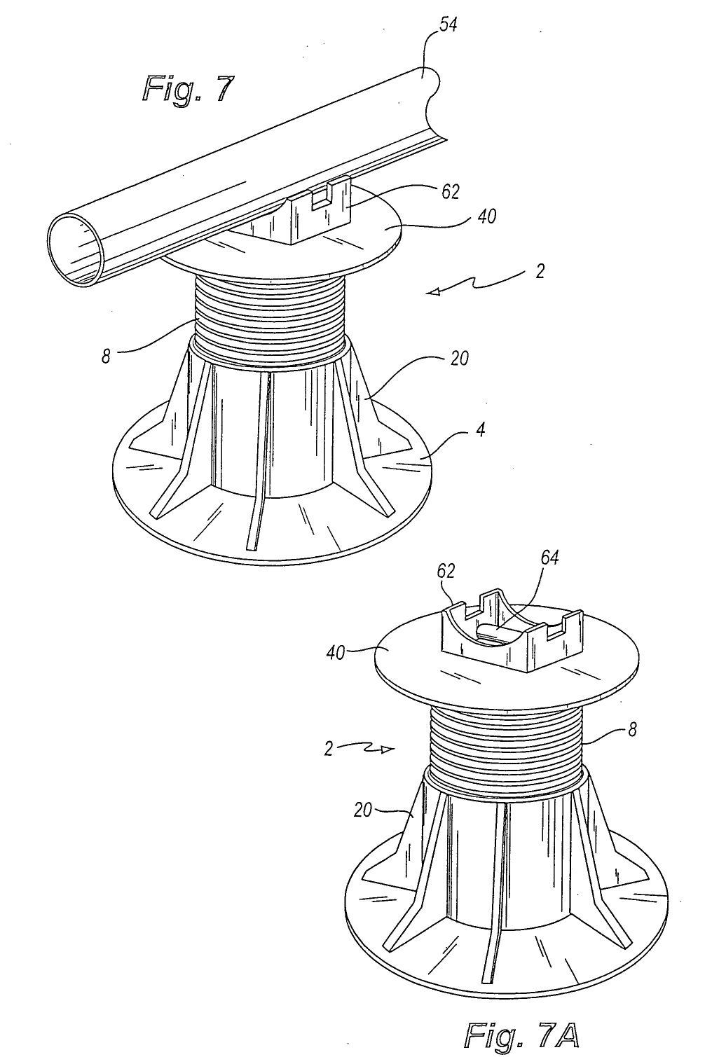

Referring now to FIG. 7, a front perspective view of one embodiment of the present invention is provided herein which is designed to support a cylindrical pipe 54 or other similar device. FIG. 7A depicts the embodiment shown in FIG. 7 with the pipe 54 removed for clarity. As shown in this particular embodiment, the adjustable support member 2 is comprised of a base member 4 and a crown member 6 with a threaded tubular stem 8. The crown member 6 further comprises an arcuate shaped pipe support 62 which is designed to substantially fit the profile or external circumference of a pipe 54 or other similar material. As appreciated by one skilled in the art, the arcuate shaped pipe support 62 on the crown 6 may have any number of diameters or shapes depending on the size and diameter of the pipe.

In a preferred embodiment of the present invention, a low friction glide roller 64 is provided to allow for expansion and contraction of the pipe 54, and which is made of a polypropylene, polyethylene, teflon (is this product name?) or other similar materials with a low coefficient of friction. As appreciated by one skilled in the art, based on the desired elevation of the pipe 54 the adjustable support piece 2 may be selectively rotated upward or downward into the base member 4 to adjust the elevation of the pipe 54 as necessary. Further, the crown 6 may be comprised of a selectively removable head 40 in a preferred embodiment which can be selectively removed or attached to the crown, and which can be quickly interchanged as necessary.

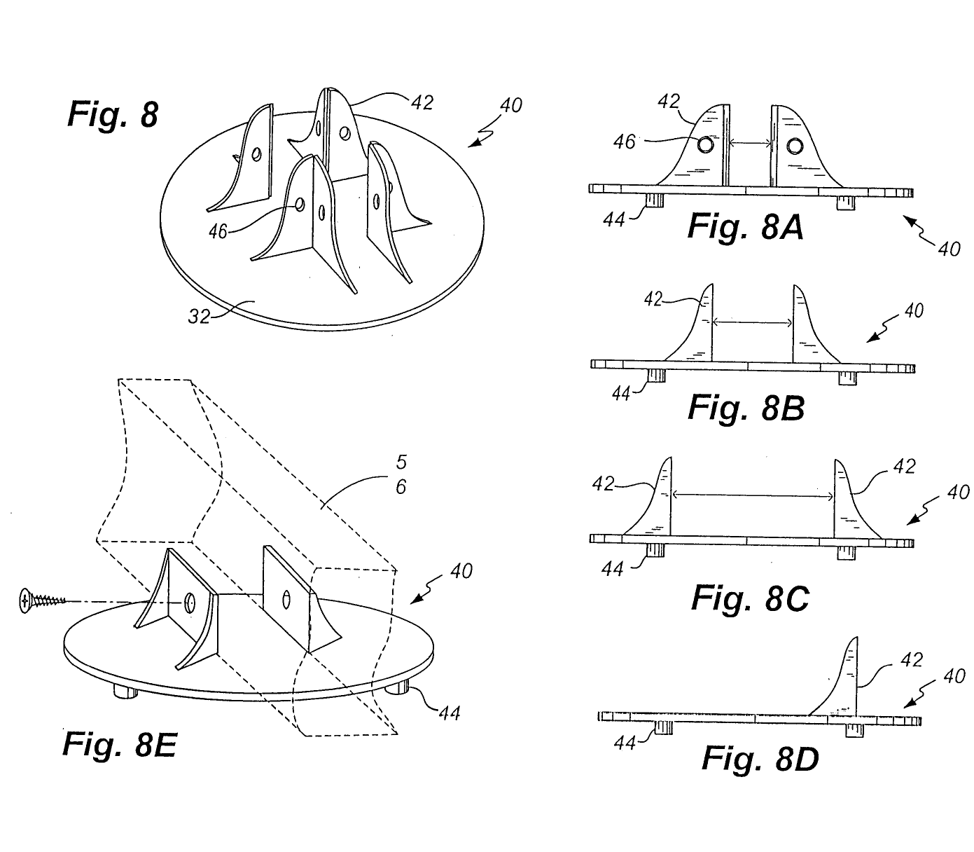

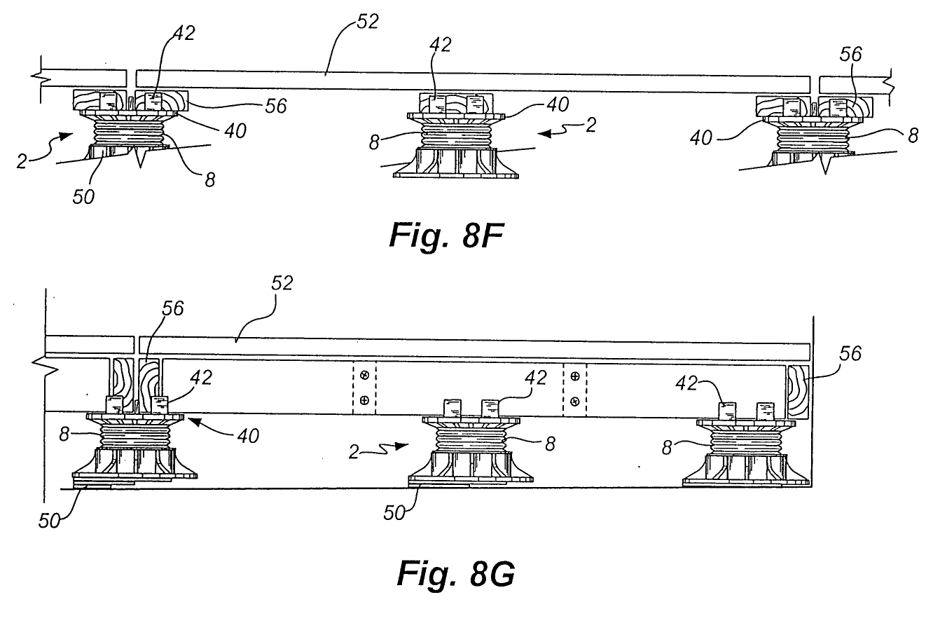

Referring now to FIG. 8-8G, numerous embodiments of the present invention are shown herein which are used to support one or more building materials typically used in the construction industry. These include 2×4 studs, 4×4 studs, facia boards and other similar materials. Referring now to FIGS. 8 and 8A, in this particular embodiment a selectively removable multi-purpose head member 40 is provided with a plurality of alignment braces 42 positioned at substantially right angles to support a building stud 56 or other similar materials which are positioned at right angles.

FIG. 8D represents an alternative embodiment of the present invention wherein a facia/rim joist may be positioned against one alignment brace 42. FIG. 8B depicts an alternative embodiment wherein a pair of opposing alignment braces 42 are adapted for supporting two 2×4 building studs 56, or one 4×4 building stud. FIG. 8C is an alternative embodiment wherein three 2×4 studs 56 may be supported by opposing alignment braces 42. FIG. 8E is a front perspective view of the embodiment shown in FIG. 8B, and identifying the position of the stud 56 during use. As appreciated by one skilled in the art, the geometric configuration of the alignment braces 42 are almost limitless, and can be designed to support or align any type of building material, including studs 56, facie boards, grating 48, pavers, etc.

Referring now to FIG. 8F-8G, the adjustable support piece 2 with the multipurpose head 40 is shown in use with a plurality of studs 56 and building planks 52 which are positioned on top of the adjustable support piece 2. As depicted in this drawing, numerous embodiments of the present invention may be used in one particular design to support one or more building materials in a preferred design layout. As additionally seen in FIG. 8F-8G, sloped compensation shims 50 may be used as necessary to support the adjustable support pieces 2 in a vertical relationship when used on inclined flooring or a non-level ground surface to assure that the building materials are level.

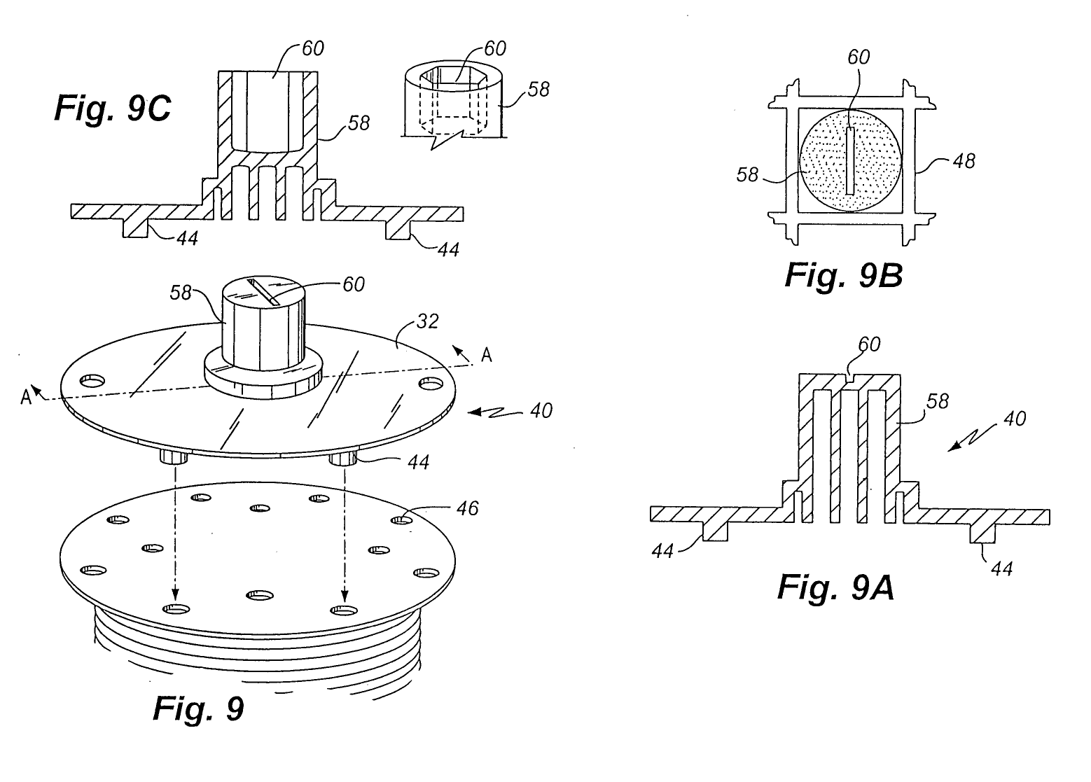

Referring now to FIGS. 9-9C, an alternative embodiment of the multi-purpose head member 40 of the present invention is shown herein. More specifically, in FIG. 9 the multi-purpose head 40 is shown detached from the adjustable support piece crown member 6, and which is held in place with one or more attachment pins 44 which are selectively aligned with one or more securement apertures 46. As further appreciated by one skilled in the art, other types of attachment means may be used to selectively attach and remove the multi-purpose head member 40 from the crown 6 of the adjustable support piece 2. The multi-purpose head 40 in the embodiment shown in FIG. 9 is adapted with a rotating slot 60 which is adapted for use with a flathead screwdriver or other similar device to rotate the multi-purpose head 40 with respect to the base member 4 and to either raise or lower the elevation of the adjustable support piece as necessary.

FIG. 9A of the present invention is a front cross-sectional elevation view of the embodiment shown in FIG. 9 taken at line “AA”, while FIG. 9B is a top plan view of FIG. 9A shown with a piece of grating 48 positioned thereon. FIG. 9C is an alternative embodiment of the invention shown in FIG. 9 which uses an alternative type of drive head suitable for use with an allen wrench, hex wrench or other type of tool with a preferred geometric profile. As appreciated by one skilled in the art, the geometric shape or design of the multi-purpose head 40 and associated alignment pin 58 may be any various shape or size based on the required needs of the contractor or home builder.

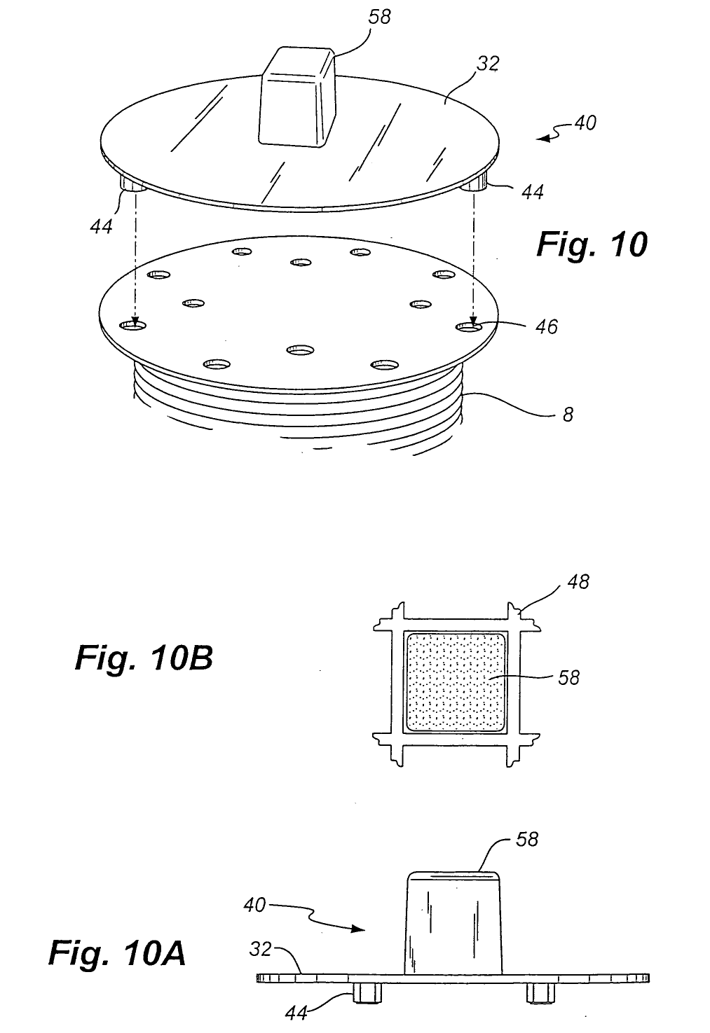

Referring now to FIG. 10, an alternative embodiment of the present invention is shown herein wherein the multi-purpose head 40 is comprised of a single, substantially cubed shaped alignment pin 58 which is adapted for positioning a sheet of grating 48, as shown in the top plan view of FIG. 110B. FIG. 10A represents a front elevation view of FIG. 10, and further identifies the attachment pins 44 which are used to selectively interconnect the multi-purpose head 40 to the crown member 6 of the adjustable support piece 2.

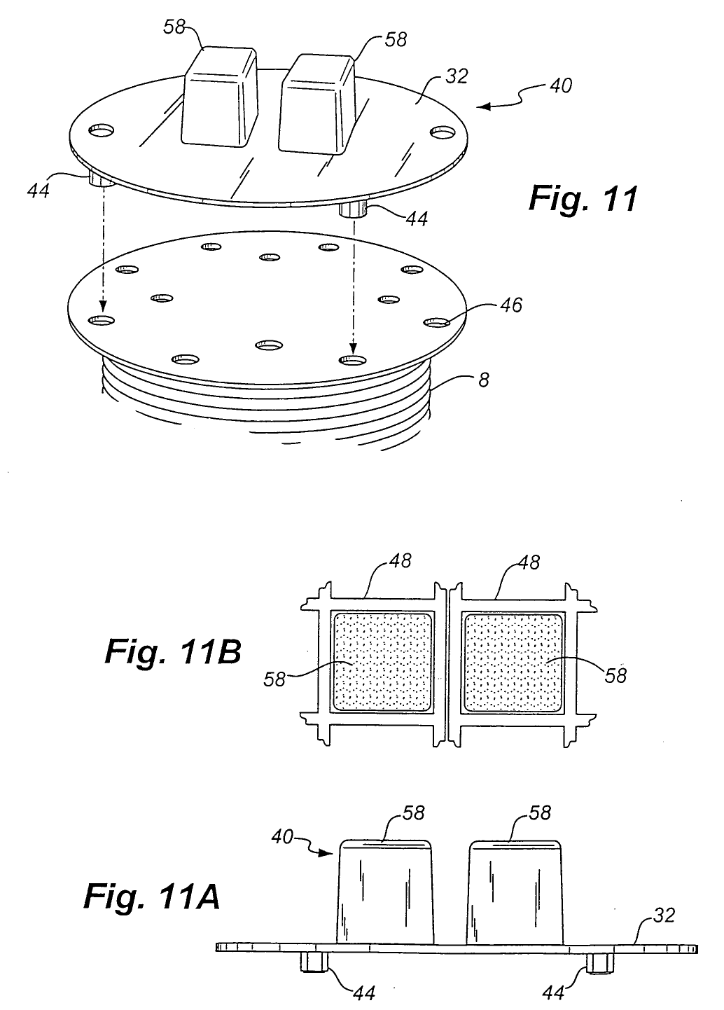

Referring now to FIG. 11-11B, yet another embodiment of the present invention is shown herein in perspective, front elevation and plan views, respectively. More specifically, two alignment pins 58 are provided on the multi-purpose head 40 and which are adapted for engaging two distinct sheets of grating material 48 as shown in FIG. 11B.

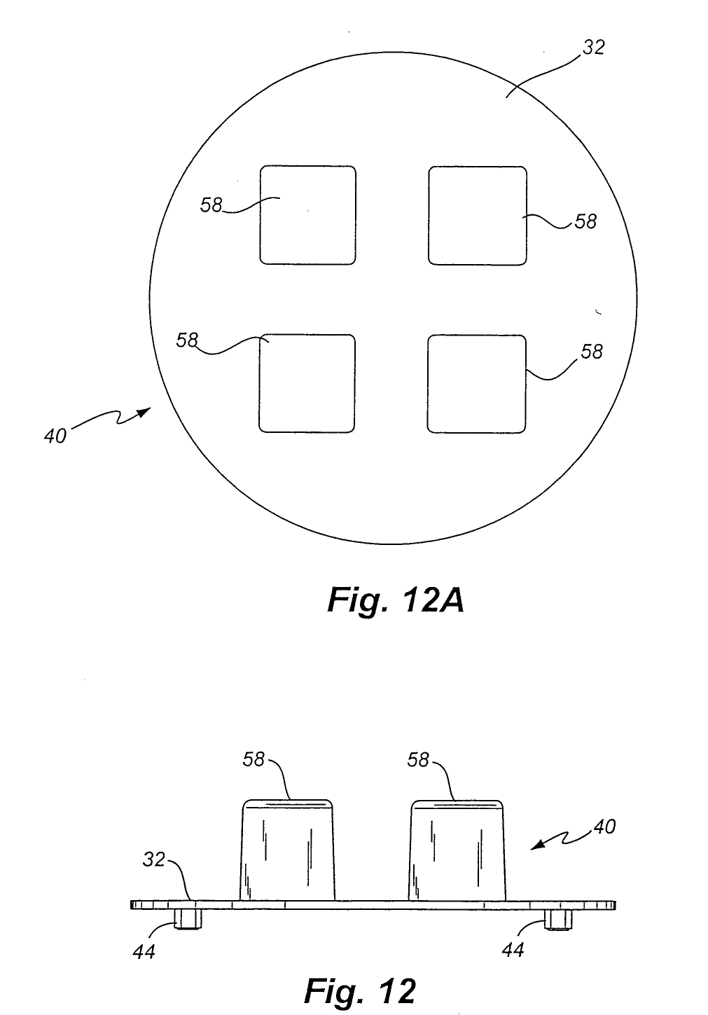

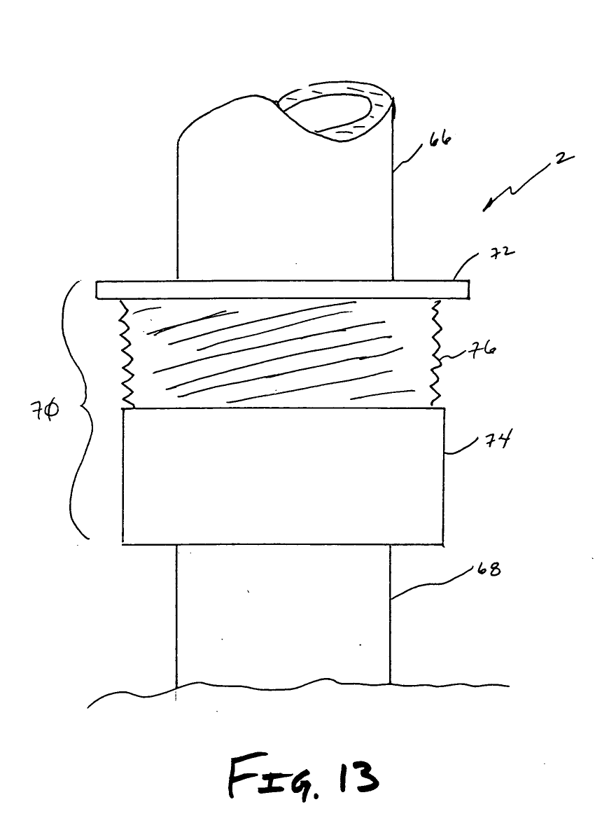

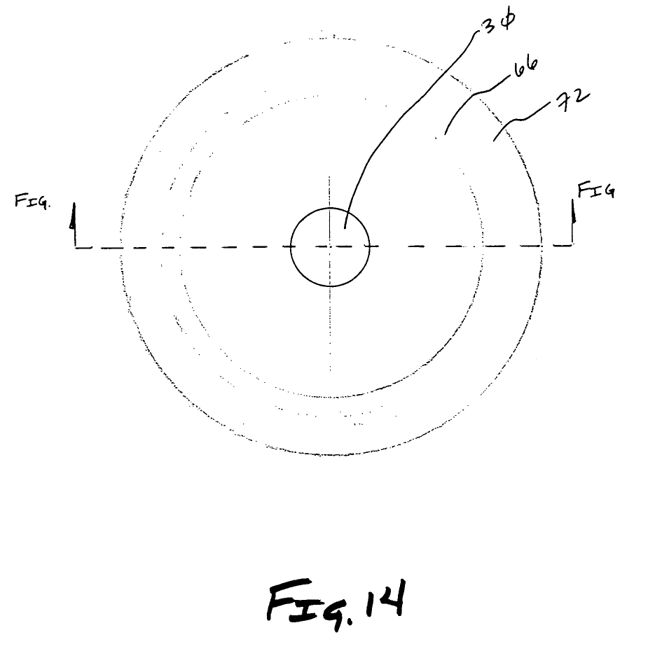

Referring now to FIG. 12, yet another embodiment of the present invention is provided herein which is shown in a front elevation view in FIG. 12 and a top plan view in FIG. 12A. In this embodiment, the multi-purpose head 40 is comprised of four distinct alignment pins 58 which are spaced to receive between one or four sheets of grating material in a given orientation. As appreciated by one skilled in the art, the multi-purpose head 40 and associated alignment braces 42 and attachment pins 44 may be comprised of a plastic material such as polypropylene, polyethylene, fiberglass, wood, metal or other similar materials. Furthermore, although drawings identify attachment pins 44 for interconnection to the crown member 6 of the adjustable support piece 2, other types of attachment means commonly known in the art may be suitable for the same purpose. More specifically, adhesives, clamps, brackets, screws, nails, and other types of attachment hardware may be suitable for selectively interconnecting the multi-purpose head 40 to the crown member 6 of the adjustable support piece 2 to provide a suitable work surface which is adapted to support one of a number of types of construction materials such as building planks 52, grating materials 48, pipes 54 or other similar materials which require support in the construction industry.

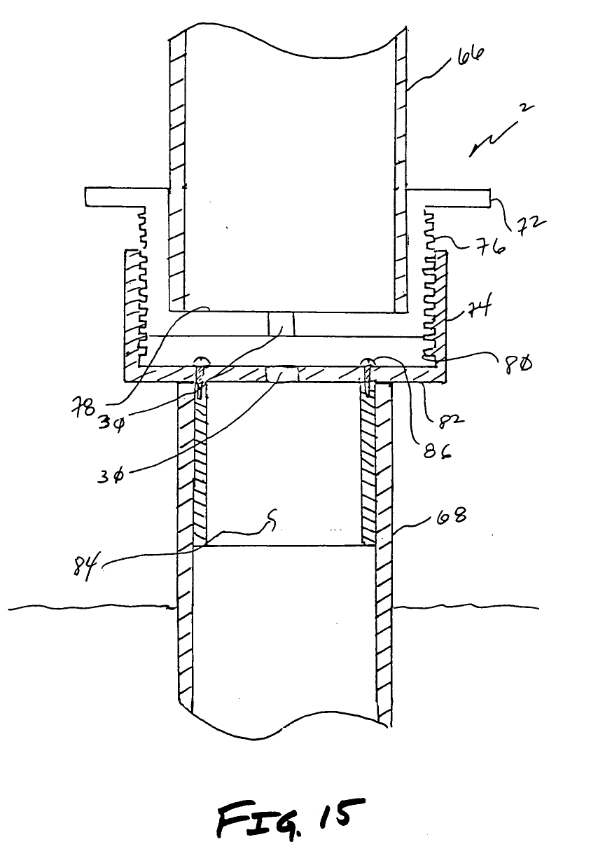

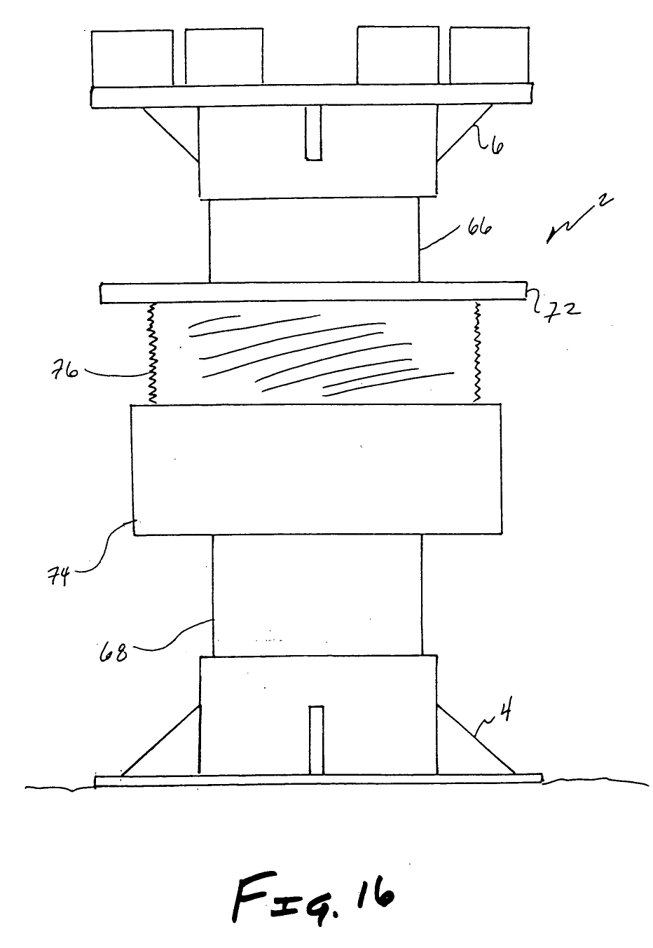

Referring now to FIGS. 13-16, still yet another embodiment of the present invention is shown that employs at least one non-threaded support member. More specifically, one embodiment of the present invention employs a non-threaded support member that engages with a coupling device that provides minute height adjustments. Preferably, one embodiment of the present invention employs an upper threaded member 66, and a lower non-threaded member 68. Alternatively, the lower portion of the adjustable support piece 2 may utilize a threaded section, while the upper portion may be comprised of a non-threaded section. It is contemplated that the non-threaded members be cut on location to a predetermined lengths to accommodate the height requirements of the flooring operation, wherein the coupling members 70 will provide minute height adjustments. Thus, rotation of either the coupling, the threaded tubular portion, the crown, or the base may facilitate selective adjustment of the elevation of the support piece 2. The coupling device 70 is preferably constructed of at least an upper coupling member 72 and a lower coupling member 74.

As illustrated herein, the non-threaded members may be hollow, solid, or a combination thereof. In addition, one skilled in the art will appreciate that although cylindrical tubes are shown herein, that any shaped tube or support member may be utilized without departing from the scope of this invention. The system illustrated herein shows non-threaded members of approximately equal diameter. However, one skilled in the art will appreciate that any diameter or combination of diameters of non-threaded members may be employed without departing from the scope of the invention.

As briefly mentioned above, the coupling device 70 of one embodiment of the present invention includes an upper coupling member 72 operably interconnected to a lower coupling member 74. The upper coupling member 72 is generally a cylindrical member with a bottom surface 78 adapted to support the upper non-threaded member 66. In addition, the upper coupling member 72 in one embodiment of the present invention includes a plurality of external threads 76. The lower coupling member 74 is also a cylindrical member with internal threads 80 that are adapted to operably interconnect to the threads 76 on the upper coupling member 72 such that small changes to the overall height of the system 2 may be made. In addition, the lower coupling member 74 has a surface 82 that is adapted for interconnection to the lower non-threaded member 68. In order to increase stability, one embodiment of the present invention employs a lower coupling member 74 with a sleeve 84 that has an outer diameter, or dimension, substantially equal to that of the inner diameter of the lower non-threaded member 68. Alternatively, the sleeve 84 may have an inner diameter, or dimension, that selectively engages the outer diameter of the lower non-threaded member. The sleeve 84 on the lower coupling member 74 provides additional resistance to bending load when the lower coupling member 74 is interconnected to the lower non-threaded member 68. The sleeve 84 may be attached in various ways to the main portion of the lower coupling member 74, for example with a fastening means 86 such as bolting, screwing, nailing, adhering, etc. Alternatively, the lower coupling member 74 and the sleeve 84 may be constructed in one piece. The coupling members also employ a plurality of apertures 30, or weep holes, that allow for the evacuation of fluids.

This embodiment of the present invention may also be interconnected to a crown member 6 and/or a base member 4 as described above. More specifically, the crown members 6 and the base member 4 may be interconnected to the upper non-threaded member 66 and lower non-threaded member 68, respectively. The crown member 6 and base member 4 in this embodiment do not include threads, such that the outer diameter of the non-threaded members may be easily engaged into the inner diameters of the crown members 6 or base members 4. Alternatively, one skilled in the art will appreciate that the crown member 6 or the base member 4 may be constructed such that they seat in the non-threaded members.

In operation, a worker initially assesses the required height of the system 2. Then, the lower non-threaded member 68 and/or the upper non-threaded member 66 is cut to achieve a portion of the desired length required. Once the height of the system 2 has been established, the lower non-threaded member 68 is stabilized by placing it into concrete, compacted soil, compacted gravel, compacted aggregate, or alternatively placed in a base member 4 that is placed on compacted soil 24 as described above. The lower coupling member 74 is then interconnected to the lower non-threaded member 68. Next, the upper coupling member 72 is operably interconnected to the lower coupling member 74 and adjusted to a predetermined height. Finally, the upper non-threaded member 66 is inserted into the upper coupling member 72. As briefly described above, a crown member 6 may be added to the upper non-threaded member 66 to provide location for interconnection to flooring members.

For clarity purposes, a detailed list of the various components of the present invention and the associated numbering is provided herein.

| Number | Component |
|---|---|
| 2 | Adjustable support piece |
| 4 | Base member |
| 6 | Crown member |
| 8 | Tubular stem |
| 10 | Threads |
| 12 | Threaded coupling |
| 14 | Alignment tabs |
| 16 | Non-skid shim pad |
| 18 | Base apertures |
| 20 | Support fins |
| 22 | Crown spacer |
| 24 | Compacted soil |
| 26 | Wood decking |
| 28 | Concrete paver |
| 30 | Drainage weep holes |
| 32 | Crown member upper planar surface |
| 34 | Base member upper planar surface |
| 36 | Tubular stem first end |
| 38 | Tubular stem second end |
| 40 | Multi-purpose head |
| 42 | Alignment braces |
| 44 | Attachment pins |
| 46 | Securement apertures |
| 48 | Grating |
| 50 | Shims |
| 52 | Building plank |
| 54 | Pipes |
| 56 | Stud |
| 58 | Alignment pin |
| 60 | Rotating slot |
| 62 | Pipe support |
| 64 | Glide roller |
| 66 | Upper non-threaded member |
| 68 | Lower non-threaded member |
| 70 | Coupling device |
| 72 | Upper coupling member |
| 74 | Lower coupling member |
| 76 | Threads |
| 78 | Bottom surface |
| 80 | Threads |
| 82 | Surface |
| 84 | Sleeve |
| 86 | Fastener |

While various embodiments of the present invention have been described in detail, it is apparent that modification and alterations of those embodiments will occur to those skilled in the art. However, it is to be expressly understood that such modifications and alterations are within the scope of the present invention as set forth in the following claims.

What is claimed is:

1. An apparatus adapted for selectively adjusting the height of a building surface, comprising:
a non-threaded cylindrical member comprising an upper end, a lower end and a length defined therebetween;
a threaded cylindrical member comprising an upper end, a lower end and a length defined therebetween;
a coupling member with a first portion adapted for selective engagement with said non-threaded cylindrical member and a second portion adapted for selective engagement with said threaded portion;
a base member having an upper surface and a lower surface, said upper surface operable interconnected to at least one of said non-threaded cylindrical member and said threaded cylindrical member, said lower surface adapted for engagement with a fixed surface; and
a crown member having an upper surface and a lower surface, said lower surface operable interconnected to at least one of said non-threaded cylindrical member and said threaded cylindrical member, and said upper surface adapted for supporting said building surface, wherein rotation of at least one of said base member, said crown member, said threaded cylindrical member and said coupling changes the elevation of said crown member with respect to the fixed surface.

2. The apparatus of claim 1, wherein said fixed surface is at least one of a region of compacted soil, a concrete footer, a cement footer, and an asphalt footer.

3. The apparatus of claim 1, wherein at least said crown member and said base member contain apertures to facilitate drainage of a fluid.

4. The apparatus of claim 1, wherein said coupling member has a first internal diameter substantially equal to an outer diameter of said non-threaded cylindrical member, and said coupling member has a second diameter with a threaded surface adapted for threaded engagement to an outer diameter of said threaded cylindrical member.

5. The apparatus of claim 1, wherein said crown member upper surface is substantially planar with at least one tab extending upwardly to engage said building surface.

6. The apparatus of claim 1, wherein the building surface comprises at least one of a paver, a tile, and a cylindrical pipe.

7. The apparatus of claim 1 wherein said coupling, said non-threaded cylindrical member, said threaded cylindrical member and said crown and said base are comprised of at lease one of a plastic material, a polyethylene, a polypropylene, a polyvinyl chloride and a fiberglass.

8. The apparatus of claim 1, wherein said crown member is threadingly engaged to said threaded cylindrical member, wherein rotation of said member changes the elevation of said crown member with respect to the fixed surface.

9. An apparatus adapted for selectively adjusting the height of a building surface, comprising:
a non-threaded tube comprising an upper end, a lower end, an outer diameter and an inner diameter;
a base comprising an upper surface and a lower surface, said upper surface comprising a support member adapted to receive said lower end of said non-threaded tube and said lower surface adapted to engage a fixed surface;
a threaded tube comprising an upper end, a lower threaded end, an outer diameter and an inner diameter;
a crown member operably interconnected to said upper end of said threaded tube, and adapted for engagement to a building surface;
a coupling member comprising a lower non-threaded portion and an upper threaded portion, wherein said upper end of said non-threaded tube slidingly engages said lower non-threaded portion of said coupling, and said lower threaded end of said threaded tube is rotationally engaged to said upper threaded portion of said coupling member, wherein rotation of at least one of said coupling member, said threaded tube and said crown member selectively adjusts an elevation of said crown member with respect to the fixed surface.

10. The apparatus of claim 9, further comprising a shim adapted to engage an upper planar surface of said crown member.

11. The apparatus of claim 9, wherein said threaded tube comprises at least one indicator device which identifies a length of said threaded tube received within said coupling member.

12. The apparatus of claim 9, wherein said non-threaded tube is comprised of at least one of a polyvinyl chloride, a polypropylene, a fiberglass, a metal and a plastic material.

13. A method for selectively adjusting a height of a building surface with an adjustable support piece, comprising the steps of:
determining an approximate height requirement of the building surface;
providing a threaded tubular member comprising an upper end and a lower end;
providing a non-threaded tubular member comprising an upper end and a lower end, to define a first length;
identifying an approximate height of the building surface;
cutting said non-threaded tubular member to make up a portion of said approximate height;
providing a crown member operably interconnected to at least one of said upper end of at least one of said threaded tubular member and said non-threaded tubular member, said crown member adapted to engage a building surface;
interconnecting a lower end of at least one of said threaded tubular member and said non-threaded tubular member into a base;
interconnecting a coupling to said threaded tubular member on a first end and said non-threaded tubular member on a second end;
vertically positioning said adjustable support piece below the building surface; and
adjusting the total length of said adjustable support piece to an optimum desired height by rotating at least one of said coupler, said threaded tubular member and said crown member, wherein the building surface is elevated to a desired level.

14. The method of claim 13, further comprising the step of orienting the adjustable support piece, wherein the threaded tubular member and said non-threaded tubular member are oriented at substantially right angels to a lower surface of the building surface.

15. The method of claim 13, further comprising positioning a non-skid shim pad on an upper surface of said crown member to inhibit shifting of the building surface.

16. The method of claim 13, wherein said adjustable support piece is capable of supporting a load of at least about 1000 lbs.

17. The method of claim 13, further comprising the step of securing said base member to a fixed surface.

18. The method of claim 13, further comprising the step of positioning a crown spacer on an upper surface of said crown member to increase said total length of said support piece.

19. The method of claim 13, wherein said cutting step comprises using a hand held saw.

20. The method of claim 13, wherein said crown member has at least a portion comprised of a sleeve with an internal diameter adapted to receive an outer diameter of said non-threaded tubular member.
